(19) United States
(12) Patent Application Publication
(10) Pub. No.: US 2005/0141341 A1
(43) Pub. Date: Jun. 30, 2005

(54) Apparatus for processing fluid products and method for the use thereof

(76) Inventors: Guido Greco, San Felice Sul Panaro (IT); Bruce Fifield, Milano (IT)

Correspondence Address: SUGHRUE MION, PLLC, 2100 PENNSYLVANIA AVENUE, N.W., SUITE 800, WASHINGTON, DC, 20037, US

(21) Appl. No.: 10/510,689

(22) PCT Filed: Apr. 7, 2003
(86) PCT No.: PCT/IB03/01309

(30) Foreign Application Priority Data
Apr. 9, 2002 (IT) BO2002A000187

(51) Int. Cl. B01F 11/00

(52) U.S. Cl. 366/209

(57) ABSTRACT

An apparatus for processing fluid products, in particular paints and the like, comprising a main structure (11) which defines a housing space (15) having an access opening (16), door means (17) which are coupled to the main structure (11) and which can be selectively moved from a closed position to an open position of at least part of the access opening (16), and vice versa, and support means (20, 22, 50) for at least one container of fluid products to be processed, which support means are housed in the main structure (11) and can be moved from an operating processing position to a position for loading/unloading the at least one container. The door means (17) comprise movement means (22, 17, 74) which mechanically interact with the support means (22, 50) in order to move them from the operating processing position to the loading/unloading position as a result of selective opening of the door means.

The present invention relates to an apparatus for processing fluid products, in particular paints and the like, comprising:
a main structure which defines a housing space having an access opening,
door means which are coupled to the main structure and which can be selectively moved from a closed position to an open position of at least part of the access opening, and vice versa,
support means for at least one container of fluid products to be processed, which support means are housed in the main structure and which can be moved from an operating processing position to a position for loading/unloading the at least one container.

The invention also relates to a method for the use of the above-mentioned apparatus.

The apparatus has been developed with particular regard, though in a non-limiting manner, to an apparatus for mixing paints and the like, contained in tins, drums or the like, the application of the same inventive principle to other machines for processing the same types of product, such as, by way of example, machines for dispensing dyes, also being of particular interest.

It is known to construct the above-mentioned door means as a simple door which is hinged to the frame or to the body of the apparatus, or as a rolling shutter which runs in horizontal or vertical guides. In order to introduce or remove a container of fluid products into/from the apparatus, it is generally necessary for an operator to open the door and to introduce one or both hand(s) inside the apparatus, moving them, for example, in the case of mixing apparatuses, towards the members for supporting and moving the container. As well as being inconvenient, these operations can pose a risk to the safety of the operator in the event of a malfunction of the safety devices, which are generally sensors which inhibit the operation of the apparatus when the door is open.

EP-A-0.796.652, on which is based the preamble of the independent claims, discloses an apparatus for mixing liquids comprising door means and support means for the containers of the liquids. The support means move from the operating to the loading position when the doors are opened, and move back to the operating position when the doors are closed; however, the movement of the support means is linked through electrical switches, control circuitry and a motor to the movement of the doors.

An object of the present invention is to overcome the problems of the prior art and, in particular, to provide an apparatus which facilitates the operations for loading and unloading the containers of fluid products, and which makes them safer and more convenient for an operator.

Another object of the present invention is to provide an apparatus which is simple and economical to produce, easy to use and highly reliable.

In order to achieve the above objectives, the invention relates to an apparatus for processing fluid products of the type mentioned in the preamble of the present description, characterized in that the door means comprise movement means which mechanically interact with the support means in order to move them from the operating processing position to the loading/unloading position as a result of selective opening of the door means. The invention further relates to a method, the features of which are set out in claim 12 below.

Owing to the features of the present invention, it is possible to construct an apparatus of the built-in type or which can be positioned in narrow locations without compromising the ease and convenience of the operations for introducing and removing a container of fluids.

According to an advantageous feature, the invention comprises sensor means for detecting the position of the support means during the operating phase. In this manner, it is possible to control the stopping of the support means within a desired zone which is predetermined relative Co the more general course taken by the support means during, for example, a mixing movement. This zone is selected so as to facilitate the operations for introducing and removing the container into/from the apparatus when the closure means are selectively opened.

A sector of particular interest for the application of the invention is that of machines for mixing fluid products which develop, during the operating phase, vibrations which may be substantial. In this case, another advantageous feature of the invention consists in that the movement means can be moved by way of the door means from a rest position, in which they are disengaged from the support means, to an engagement position, in which they engage with the support means in order to move them from an operating processing position to a loading/unloading position. In this manner, it is possible to isolate the door means from the means for supporting the container, and thereby to prevent the vibrations generated during the movement of the container from being transmitted to the door, and more generally to the body of the apparatus.

According to an additional advantageous feature, the apparatus comprises at least one device for absorbing the vibrations in order to absorb the vibrations produced when the support means are in the operating processing position. In a preferred embodiment, the support means in the operating phase are coupled and supported exclusively by a damping frame which is provided with dampers, which absorb the vibrations produced by, for example, mixing members, which are connected to the support means in such a manner that the vibrations are not transmitted to other parts of the structure.

Further characteristics and advantages will become clear from the following detailed description which is given with reference to the appended drawings which are provided purely by way of non-limiting example and in which:

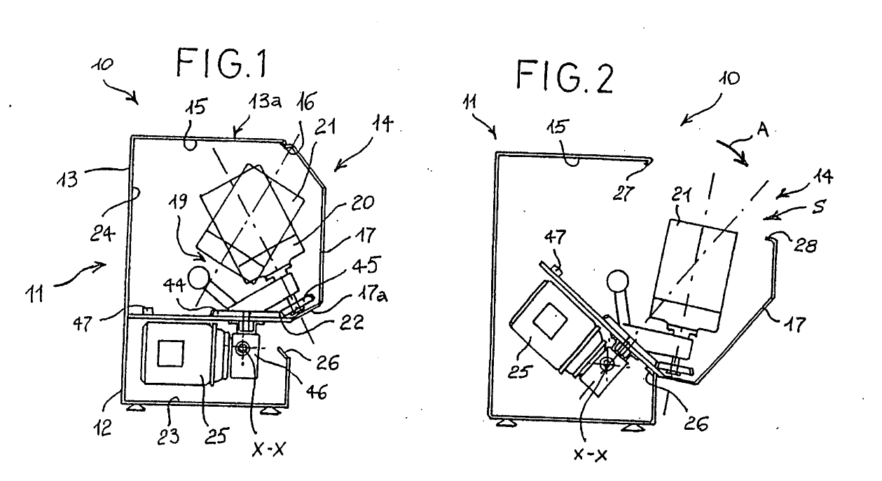

FIG. 1 is a schematic side view of an apparatus for mixing fluids according to the invention, in an operating position in which a side panel of the body has been removed for reasons of clarity of illustration,

FIG. 2 is a view similar to that in FIG. 1, in which the apparatus is in a loading/unloading position,

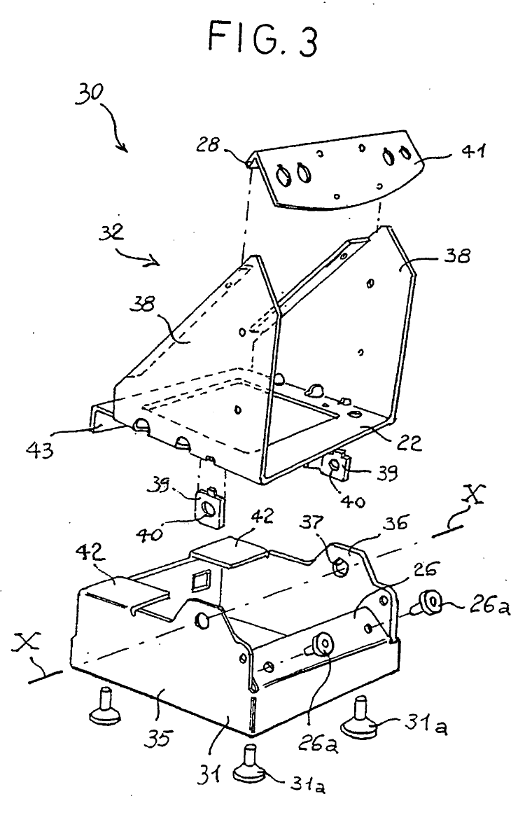

FIG. 3 is a perspective exploded view of the carrier structure of the apparatus in FIG. 1,

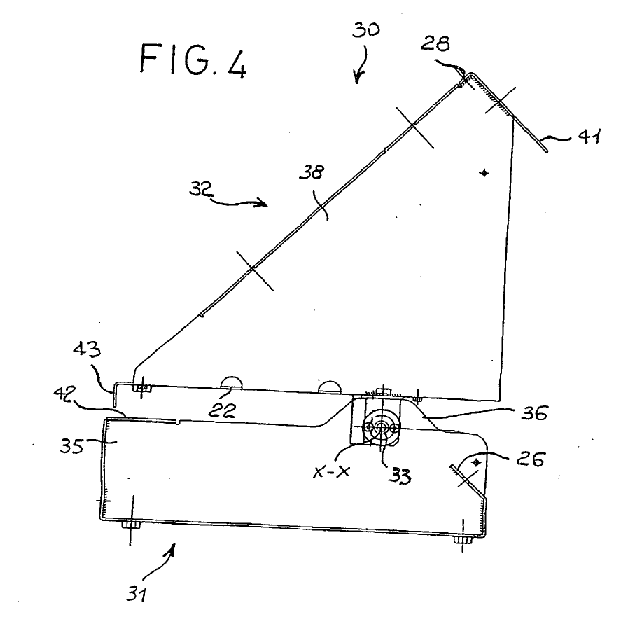

FIG. 4 is a longitudinal section of the carrier structure, as in FIG. 3, in the assembled configuration,

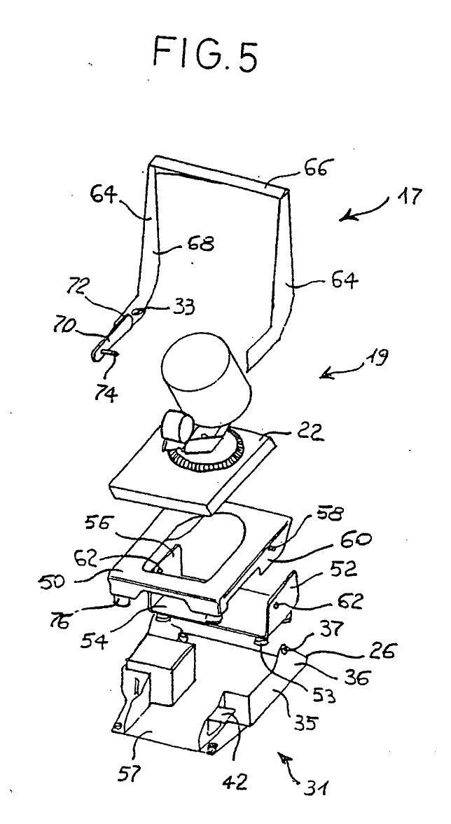

FIG. 5 is a perspective exploded view of a variant of the apparatus in FIG. 1, in which, for reasons of clarity of illustration, the side panels of the apparatus and the relevant anti-vibration support feet have been removed, and

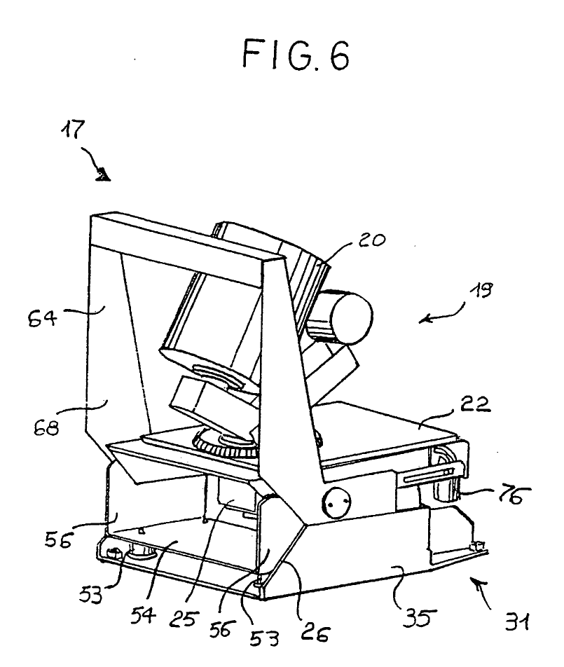

FIG. 6 is a perspective view of the members in FIG. 5 in the assembled state.

With reference to the Figures, an apparatus 10 for mixing fluid products comprises a main structure 11 having a base portion 12, an upper portion 13 and a front portion 14. The main structure 11 defines and delimits a housing space 15 accessible from a front access opening 16 which can be closed at least partially, in a preferable but non-limiting manner, by a door 17 which is hinged to the main structure 11 so as to be coupled to the front portion 14, by pivoting about a horizontal axis X-X, orthogonal to the plane of the sheet of paper in FIGS. 1, 2 and 4.

An opening stop abutment 26, which is described in greater detail below, is arranged at the lower end of the access opening 14 so as to limit the opening of the door 17, providing an abutment for the lower portion 17a of the door 17 (see FIG. 1). A closing stop abutment, or turned-over stop portion 27, can be arranged at the upper end of the access opening 14 and provides an abutment for a turned-over portion 28 formed at the top of the door 17 when the door 17 is closed (see FIG. 2). As an alternative or in addition to this solution, an anti-vibration stop abutment can be arranged in the lower portion 12 of the main structure 11, which abutment is produced by interposing damping devices 76 (see FIGS. 5 and 6) between a plate 22, connected to the door 17, and flat portions 42 which are integral with the main structure 11 and which are described in greater detail below.

A mixing device 19 which operates in known manner is housed inside the housing space 15. In the embodiment illustrated, reference is made, in a non-limiting manner, to a mixing device in which the fluid product container is subjected to a movement of conical revolution and, contemporaneously, of rotation about its own axis. In particular, the mixing device 19 comprises, in a preferable but non-limiting manner, a support member 20 of the drum type, or of any other type which is functionally suitable, in use, for supporting at least one container 21 of fluid products to be mixed. The mixing device 19 is mounted on the plate 22 which projects inside the housing space 15.

The plate 22 divides the housing space 15 into a lower space 23 and an upper space 24. Driving means 25 for operating the mixing device 19 are housed in the lower space 23 and are preferably connected to the lower side of the plate 22, even though it is possible to provide alternative means of connection to the mixing device 19, for example, of the coupling type, so that the driving means 25 can be connected to the lower portion 12 of the main structure 11 and selectively coupled to the mixing device when the mixing device is in the operating state illustrated in FIG. 1. The driving means 25 comprise, in a preferable but non-limiting manner, an electric motor.

In the example of the Figures, the mixing device 19 comprises a first gear 44 and a second gear 45 which form a gear train having a transmission ratio, in a preferable but non-limiting manner, of 2:1 and which can, in use, transmit a movement of rotation about two separate axes to the support member 20. The two gears 44 and 45 are driven by the motor 25, preferably by way of a transmission having gearing 46 without belts or pulleys being interposed. Sensor means 47 are also arranged inside the housing space 15 in order to detect, during the operating phase, the position of the support means 20.

FIGS. 3 and 4 illustrate in greater detail some structural features of the main structure 11. In particular, a carrier structure 30 comprises a fixed portion 31 and a movable portion 32. The fixed portion 31 contributes to the definition of the base portion 12 of the main structure 11 and provides support for the apparatus 10 by means, for example, of feet 31a, which are preferably of the adjustable type.

The fixed portion 31 is preferably produced by bending and/or welding a sheet, and comprises an upper side, which is at least partially open, a front portion, on which the abutment 26 is constructed or carried, and two lateral walls 35, on which there are formed two fins 36 which project upwards and in which holes 37 for the insertion of rotation pins 33 are formed. Pads 26a or similar means can be mounted on the stop abutment 26 in order to deaden the impact of the lower portion 17a of the door 17 and/or to adjust the maximum opening position of the door 17. One or more flat portions 42, formed on the upper side of the fixed portion 31, provide a support for the plate 22 in the operating position of the apparatus 10, illustrated in FIG. 1, and in particular for an end edge 43 thereof.

The movable portion 32 contributes to the definition of the structure of the door 17 and is pivotally articulated to the fixed portion 31, for example, by means of the rotation pins 33, which are arranged parallel with axis X-X (see FIG. 4). The movable portion 32 comprises the base plate 22 and two shaped lateral walls 38, to which it is possible to attach panels of the desired shape (not illustrated) in order to close at least partially the access opening 16. Plates 39 are connected to the shaped walls 38; the plates 39 project downwards and holes 40 formed therein are arranged so as to be coaxial with the holes 37 for the insertion of the rotation pins 33. A plate 41, which is bent at the end to form the abutment 28, is connected to the upper portion of the shaped walls 38.

FIG. 1 illustrates the relative position of the various parts of the apparatus 10 during the operating phase, wherein the door 17 closes at least partially the access opening 16 and the mixing device 19 is completely housed in the housing space 15.

On the other hand, FIG. 2 illustrates the apparatus 10 in the position for loading/unloading the at least one container 21, which is brought about by opening the door 17 in the direction of arrow A, with pivoting about axis X-X. In this position, the access opening 16 is at least partially open and the support member 20 of the container 21 moves, at least partially, out of the opening.

With reference to FIGS. 5 and 6, a variant of the apparatus 10 provides for the mixing device 19 to be mounted on a plate 22 which is rigidly connected to a movable frame 50, constructed, for example, from bent sheet metal. The movable frame 50 is pivotally mounted on a damping frame 52 in order to absorb the vibrations which are generated when the mixing device 19 is operating. The damping frame 52 comprises, in a preferable but non-limiting manner, a bottom side 54 which is substantially parallel with the ground and two lateral wings 56 which project so as to be orthogonal to the bottom side 54. The damping frame 52 is fixed relative to the fixed portion 31 and is connected to the bottom side 57 thereof by means of dampers 53. The articulation between the movable frame 50 and the damping frame 52 can be brought about, for example, by introducing pins 58 which are mounted on two lateral fins 60, which are formed at the sides of the movable frame 50, into corresponding holes 62 produced in the two lateral wings 56 of the damping frame 52.

The door 17 comprises two L-shaped parts 64 which are connected to a handle 66 so as to have faces 68 parallel with each other and with sufficient spacing to enclose externally the movable frame 50. A pin 33 is mounted on each face 68 and projects substantially orthogonally to the face 68 towards the interior of the apparatus. The door 17 is pivotally mounted on the fixed portion 31 by the coupling of the pins 33 in the respective holes 37 formed in the wings 36 of the fixed portion 31. At least one of the two L-shaped parts 64 extends, at one end 72 thereof, by means of an extension 70, on which a lifting pin 74 is mounted, which is intended to engage with the movable frame 50 during the opening of the door 17. However, the lifting pin 74 remains spaced from the movable frame 50 during the mixing phase.

Damping devices 76, such as, for example, rubber pads, can be mounted under the movable frame 50 and are intended to rest, during the mixing movement, on flat portions 42 which are formed on the fixed portion 31, for greater stability and absorption of the vibrations, or in addition, in a preferable but non-limiting manner, in order to provide an abutment for stopping the pivoting of the door 17 in the opposite direction to that of arrow A (FIG. 2).

The result which is obtained by the measures adopted in the variant described is that of rendering the mixing means 19 completely free of the door 17 during the operating phase, by providing for their support only by means of the damping frame 52 and optionally by means of the fixed portion 31, so that the vibrations generated by the operation of the mixing means are absorbed by the dampers 53 and 76 without affecting the door 17 or the body of the apparatus 10. During the opening of the door 17, by pivoting about the pin 33, the pin 74 moves into abutment with the lower portion of the movable frame 50 so as to lift it, causing the movable frame 50 to pivot about the pin 58. The movable frame 50 thereby moves from the operating position to the loading and unloading position, in which the support member 20 can readily be reached by the operator.

According to a preferred method for use of the apparatus 10, after opening the door 17, an operator places at least one container 21 on the support member 20, which is readily accessible because it is partially protruding from the access opening 16. In closing the door 17 in the opposite direction to arrow A in FIG. 2, the apparatus 10 is moved into the operating position illustrated in FIG. 1. At this point, it is possible to start the mixing phase, preferably by activating the motor 25 in accordance with an acceleration gradient, in order to achieve a desired operating state, which is maintained for the time required for mixing. At the end of the mixing phase, the motor 25 and consequently the support member 20 are stopped. If sensor means 47 are provided, the motor 25 is arranged to be switched off when those sensor means 47 detect that the support 20 has reached a desired position.

The stopping of the support member 20 in a predetermined position, preferably in the position indicated by arrow S in FIG. 2, can be brought about by mechanical means or arresting brake means, or even by determining beforehand the distance travelled by the support member 20 owing to inertia following the deactivation of the motor 25. In a preferable but non-limiting manner, the preferred stop position S is located in a front sector which is equal to approximately 20°. In order to promote reaching of the preferred stop position S, it is possible to operate the motor 25 at reduced speed at the end of the mixing cycle, in a preferable but non-limiting manner, by reducing the speed to a level suitable for ensuring stopping within the predefined limits.

When the mixing device 19 is stopped, it is possible to open the door 17 in the direction of arrow A in FIG. 2 in order to move automatically the support member 20 into the loading/unloading position, in which the operator can readily and conveniently remove the container 21 from the apparatus 10.

A person skilled in the art will have no difficulty in applying the principle of the invention to devices which operate according to mixing methods which are different from that described and illustrated, such as, for example, to vibration or gyroscope type devices. Furthermore, the configuration and arrangement of the elements of the present invention must not be taken to be limited to the above-mentioned example, but instead can be modified according to the specific requirements of use. Accordingly, the access opening 16 and the relevant closing means, such as the door 17, can also extend partially to other portions of the structure, in addition to the front portion. In particular, it is possible for the access opening 16 also to extend, in part, to the upper side 13a of the upper portion 13, in such a manner that access to the support member 20 of the container can be brought about partially from above, this being particularly advantageous from an ergonomic point of view in the case of a mixer which is relatively low.

The door 17 mentioned in the above detailed description can naturally be replaced by any device which can provide at least partial closure of the housing space 15, such as, for example, systems having shutters, gates or the like.

Although the above description is given with reference to a device for mixing fluid products, the invention does not have to be considered to be limited to the scope of application of the example, but may also be employed in apparatuses of different types, for example, machines for dispensing dyes for paints and the like.

Naturally, the principle of the invention remaining the same, the characteristics of construction and forms of embodiment may be varied widely with respect to those described and illustrated, without thereby departing from the scope of the present invention.

1. An apparatus for processing fluid products, in particular paints and the like, comprising:
a main structure (11) defining a housing space (15) with an access opening (16),
door means (17) coupled to the main structure (11) and selectively movable from a closed position to an open position of at least part of the access opening (16), and vice versa,
support means (20, 22, 50) for at least one container of fluid products to be processed, housed in the main structure (11) and movable from an operating processing position to a position for loading/unloading the at least one container,
characterized in that the door means (17) comprise movement means (22, 17, 74) mechanically interacting with the support means (22, 50) so as to move them from the operating processing position to the loading/unloading position as a result of selective opening of the door means.

2. An apparatus according to claim 1, characterized in that the support means comprise at least one support member which is operatively movable (20) in order to support and move the at least one container in an operating processing phase for the fluid products.

3. An apparatus according to claim 2, characterized in that it comprises driving means (25, 44, 45, 46) which are connected firmly to the support means (22, 50) in order to impart, in use, a mixing movement to the at least one movable support member (20).

4. An apparatus according to claim 2, characterized in that the movement means (74) can be moved by way of the door means (17) from a rest position, in which they are disengaged from the support means (22, 50), to an engagement position, in which they engage with the support means (22, 50) in order to move them from the operating processing position to the loading/unloading position.

5. An apparatus according to claim 2, characterized in that it comprises damping means (52, 53, 76) to absorb the vibrations produced by the operatively movable support member (20) during the operating processing phase for the fluid products.

6. An apparatus according to claim, characterized in that the support means (50) are fixed to the main structure (11) with damping means (52, 53) being interposed.

7. An apparatus according to claim 6, characterized in that the damping means (52, 53) comprise a damping frame (52), on which the support means (50) rest, and dampers (53) which are fixed to the main structure (11).

8. An apparatus according to claim 1, characterized in that it comprises damping devices (76) which are mounted under the support means (22, 50) so as to move into abutment, in the operating position, with fixed surfaces (42) which are integral with the main structure (11).

9. An apparatus according to claim 1, characterized in that the support means (20) are fixed to the door means (17).

10. An apparatus according to claim 1, characterized in that the door means (17) are hingedly connected in an articulated manner to the main structure (11) so as to be able to be opened according to a tilting movement.

11. An apparatus according to claim 1, characterized in that it comprises sensor means (47) for detecting the position of the support means.

12. A method for using an apparatus for processing fluid products according to claim 1, characterized in that it comprises the following phases:
positioning at least one container for fluid products to be processed on the support means (20, 22, 50) in the housing space (15) of the main structure (11),
operating the apparatus for a predetermined period of time suitable for processing the fluid products, the door means (17) being in a closed position,
moving the door means (17) from the closed position to an open position to mechanically bring about the movement of the support means (20, 22, 50) from the operating processing position to the loading/unloading position in order to remove at least partially the at least one container from the housing space (15).

13. A method according to claim 12, characterized in that the apparatus is a machine for mixing fluid products, the operation of the apparatus comprising the following phases:
activating driving means (25, 44, 45, 46) in order to move the at least one movable support member (20) for a predetermined time for mixing the fluid products contained in the at least one container,
detecting the presence of the at least one movable support member in a predetermined position by sensor means,
stopping the driving means upon the expiry of the predetermined time and when detection by the sensor means takes place.

14. A method according to claim 12, characterized in that the activation of the driving means comprises a final phase, in which the driving means are operated at a reduced speed in order to slow down the movement of the at least one movable support member before it is stopped and before the detection by the sensor means takes place, the movement of the at least one movable support member continuing owing to inertia following the stopping of the driving means.

15. A method according to claim 12, characterized in that the positioning of the at least one container in the housing space comprises the following phases:
positioning the at least one container on the support means and
moving the door means (17) from the open position to the closed position in order to mechanically bring about the movement of the support means (20, 22, 50) from the loading/unloading position to the operating processing position for the fluid products.
